(19) United States
(12) Patent Application Publication
(10) Pub. No.: US 2020/0016476 A1
(43) Pub. Date: Jan. 16, 2020

(54) ROBOTIC BILLIARDS, POOL AND SNOOKER

(71) Applicants: Kenneth C. Miller, Aptos, CA (US); John Nicholson, Aptos, CA (US)

(72) Inventors: Kenneth C. Miller, Aptos, CA (US); John Nicholson, Aptos, CA (US)

(21) Appl. No.: 16/507,802

(22) Filed: Jul. 10, 2019

Related U.S. Application Data
(60) Provisional application No. 62/696,137, filed on Jul. 10, 2018.

(51) Int. Cl. A63D 15/00; B25J 11/00; B25J 13/00

(52) U.S. Cl. CPC A63D 15/00; B25J 13/006; B25J 11/003

(57) ABSTRACT

A game played on a billiards/pool/snooker table is provided that includes at least one robot assigned to temporally to one of two or more players, or two or more robots, each assigned uniquely to each of the two or more players. A remote controller is in electrical or wireless communication with the at least one robot or the two or more robots, each of the individually two or more remote controllers assigned to the two or more players for control of the two or more robots. Two or more color-coded or numbered balls are provided to be engaged by the robots.

### RELATED APPLICATIONS

This application is a non-provisional application that claims priority benefit of U.S. Provisional Application Ser. No. 62/696,137 filed 10 Jul. 2018; the contents of which are hereby incorporated by reference.

### FIELD OF THE INVENTION

The present invention in general relates to sports games, and in particular to robotic based games played on a billiards/pool/snooker table.

### BACKGROUND OF THE INVENTION

Billiards/pool/snooker sports are a wide variety of games of skill generally played with a cue stick, a cue ball, and a set of game balls on a billiards/pool/snooker table. A billiards/pool/snooker table is bounded by elastic bumpers known as cushions. Some billiards/pool/snooker games are played on rectangular tables containing a set of six holes (or pockets)—one in each corner (four corner pockets) and one in the center of each long side (two side pockets). Billiards/pool/snooker tables are typically covered with a felt material to impart a damping effect on the rolling action of the game balls. The set of pool game balls usually come in a numbered sequence of 1 to 15 in stripes (numbers 1 to 8) and solids (numbers 9 to 15) graphics to distinguish sets of balls for various games. A white cue ball is typically used in conjunction with the cue stick controlled by the players to hit the cue ball into the game balls with the object of moving the game balls into the pockets of the billiards/pool/snooker table. Many billiards/pool/snooker games and variations of games have been developed over time.

One of the more popular pool games is called eight-ball. Eight-ball is played with cue sticks and sixteen balls: a cue ball, and fifteen object balls consisting of seven striped balls, seven solid-colored balls and the black eight ball. After the balls are scattered with a break shot, the players are assigned either the group of solid balls or the stripes once a ball from a particular group is legally pocketed. The ultimate object of the game is to legally pocket the eight ball in a called pocket, which can only be done after all of the balls from a player's assigned group have been cleared from the table. There are many rules and variations to the game of eight-ball

Depending on the game being played and the skill of the players, billiards/pool/snooker, when played in groups of two or more people is generally very slow and time consuming. With eight-ball, each player having to take turns hitting the cue ball into the object balls via the cue stick until all of a player's object balls have been cleared from the table into the pockets, and then having to hit the 8 ball into a called pocket, the game can take a long time to play. Players must wait for their turn during other player's shots, and after missing a shot they are idle while others shoot. With the advent of computer games, augmented reality, laser tag, paint ball, and other live action games, the popularity and appeal of traditional billiards/pool/snooker games continues to wane as young adults continue to favor faster paced action games.

Thus, there is a need for enhanced games played on billiards/pool/snooker tables to improve the appeal of the billiards/pool/snooker game venue to younger adults.

### SUMMARY OF THE INVENTION

A game played on a billiards/pool/snooker table is provided that includes at least one robot assigned to temporally to one of two or more players, or two or more robots, each assigned uniquely to each of the two or more players. A remote controller is in electrical or wireless communication with the at least one robot or the two or more robots, each of the individually two or more remote controllers assigned to the two or more players for control of the two or more robots. Two or more color-coded or numbered balls are provided to be engaged by the robots.

### BRIEF DESCRIPTION OF THE DRAWINGS

The present invention is further detailed with respect to the following drawings that are intended to show certain aspects of the present of invention, but should not be construed as limit on the practice of the invention, where like numbers have the same meaning in the different drawing views, and wherein:

FIG. 1A is a top view of an embodiment of a robot operative in embodiments of the present invention;

FIG. 1B is a side view of the robot shown in FIG. 1A;

FIG. 2A is a side view of an embodiment of a robot with an attachment operative in the present invention; and

FIG. 2B is a top view of the robot with the attachment shown in FIG. 2A.

FIG. 3 is a system view of an embodiment of a billiards/pool/snooker table with robot, balls, and controllers networked to a computer for playing games in accordance with embodiments of the invention;

FIG. 4 is a top view of an embodiment of a table with corner blocks in accordance with embodiments of the invention;

FIG. 5A is a perspective view of a corner block of FIG. 3.

FIG. 5B is a perspective view of a single stall corner block with one ball stall slot to place a single game ball in during game play in accordance with embodiments of the invention;

FIG. 5C is a perspective view of a multi stall corner block with multiple ball stalls to place multiple game balls in during game play in accordance with embodiments of the invention;

FIG. 5D is a top view of an additional corner block;

FIG. 5E is front view of the additional corner block feature of FIG. 5D;

FIG. 5F is a perspective view of the additional corner block feature of FIG. 5D;

FIG. 6 is a top view of an embodiment of a table with the various corner blocks shown in FIGS. 5A-5C.

FIG. 7A is a perspective view of a side block in accordance with embodiments of the invention;

FIG. 7B is a perspective view of a single stall side block with one ball stall slot to place a single game ball in during game play block in accordance with embodiments of the invention;

FIG. 7C is a perspective view of a multi stall side block with multiple ball stall slots to place multiple game balls in during game play in accordance with embodiments of the invention;

FIG. 7D is a top view of an additional side block;

FIG. 7E is front view of the additional side block feature of FIG. 7D;

FIG. 7F is a perspective view of the additional side block feature of FIG. 7D;

FIG. 8 is a top view of an embodiment of a table with four single stall corner blocks and two single stall side blocks;

FIG. 9 is a perspective view of a multi stall center block with multiple ball stall slots to place multiple game balls in during game play in accordance with embodiments of the invention;

FIG. 10 is a top view of an embodiment of a table with four single stall corner blocks, two single stall side blocks and two multi stall center blocks in accordance with embodiments of the invention;

FIG. 11 is a side perspective view of an embodiment of a table with four single stall corner blocks, two single stall side blocks and two multi stall center blocks, where the total number of stalls in this configuration is fourteen, which corresponds to the maximum number required for an equal number of stripe and solid pool balls so that each ball has an available stall slot;

FIG. 12A is a top view of a multi stall center block with slots for the addition of gates and holes for mounting to horizontal surfaces with screws or bolts in accordance with embodiments of the invention;

FIG. 12B is a perspective view of a multi stall center block with stops for gates in the open and closed positions as well as anti-rotation tabs for locking the block to a foam stadium mat in a desired orientation in accordance with embodiments of the invention;

FIG. 12C is a side view of a multi stall center block with a locating feature to position the block on a foam stadium mat in a desired location in accordance with embodiments of the invention;

FIG. 12D is an underside perspective view of a multi stall center block with pads to locate and secure Velcro™ hook patches or suction cups which are used to hold the block in place on a game mat, table, or floor in accordance with embodiments of the invention;

FIG. 13A is a side view of a reversible multi stall center block above a foam stadium mat with one side for mounting to a floor, table, or game mat and the other side for mounting to the foam stadium mat in accordance with embodiments of the invention;

FIG. 13B is a perspective view of the multi stall center block above the foam stadium mat of FIG. 13A in accordance with embodiments of the invention;

FIG. 13C is a perspective view of the multi stall center block positioned on the foam stadium mat in accordance with embodiments of the invention;

FIG. 14A is a view of a reversible block gate with an opening for a game ball to pass through and a wall to block a ball from passing through, with a set of tabs to locate the gate in the horizontal plane and stops to locate the gates in the vertical plane of the various blocks in accordance with embodiments of the invention;

FIG. 14B is a view of a reversible block gate with a game ball number indicator in accordance with embodiments of the invention;

FIG. 15A is a perspective view of a multi stall center block with block gates installed in the closed position in accordance with embodiments of the invention;

FIG. 15B is a front view of a FIG. 15A showing the multi stall center block with the block gates installed in the closed position;

FIG. 16A is a perspective view of a multi stall center block with block gates installed in the open position in accordance with embodiments of the invention;

FIG. 16B is a front view of FIG. 16A showing the multi stall center block with block gates installed in the open position;

FIG. 17 is a detailed perspective view of an embodiment of a gate module featuring decorations, displays, communications, electronics, batteries, robot weapon targets, sensors, scoring goals, ball kickers, scoring bumpers, indicator lights, motorized gates, and power receivers for receiving transmitted power;

FIG. 18 is a perspective view of an embodiment of a table with various blocks and a gate module in a side position on the table;

FIG. 19 is a partial perspective view of an embodiment of a table with various blocks and a gate module in a corner position on the table;

FIG. 20 is a perspective view of an embodiment of a table with various blocks and a gate module in a central position on the table; and

FIG. 21 is a top view of an embodiment of a game mat featuring different size table graphics, indicators for locating Velcro loops to secure blocks, indicators for robot starting point locations, game play graphics, extended edges to tuck under table bumpers, cut lines for pool and snooker table pockets, indicators for game ball starting locations, indicators for alternate game ball starting locations, indicators for locating blocks, quick response (QR) codes for accessing apps and website, cosmetic graphics, and advertising graphics;

### DETAILED DESCRIPTION OF THE INVENTION

The present invention has utility as versions of enhanced games played on billiards/pool/snooker tables to improve the appeal of a game table venue to younger adults. Embodiments of the invention utilize a set of game playing robots that are individually assigned to each player for game play that in a specific embodiment constitutes a race. Each of the individually assigned robots push a color-coded or numbered set of balls that are also assigned to each player. Typically, each player would be assigned an even quantity of balls, but to even out the game for players of different skill levels, different quantities of balls may be assigned to different players with the more skilled player having more assigned balls. The object of the game is to push the assigned set of balls off the billiards/pool/snooker table into the pockets. Players may control their assigned robot with a dedicated wireless controller, or via a downloadable application (app) on a tablet or smartphone brought to the billiards/pool/snooker table venue by the player. The billiards/pool/snooker table venue may have a central computer that networks with the robots and player controllers, or with the app on the smartphones or tablets. The central computer may be used to track game results, race results, times, player standings, and other game based statistics. Embodiments of the robots may have attachments (arms, probes, pushers, etc.) so that a robot can guide the balls more easily.

Billiard/pool/snooker table venues may require (if necessary) temporary modifications and/or additions to protect the felt covering the table and provide additional play functionality. Examples of temporary modifications and/or additions illustratively include game mats, pocket blocks, pocket blocks with slots that act as ball stalls, corner modules, side modules, center modules, scoring bumpers, and ball kickers.

Game mats—have several features and functions including: protection of the billiards/pool/snooker table felt cover; graphics for indicating the set-up of the game prior to starting play; a listing of rules of the game; advertising graphics for billiard table venues; sponsorship graphics by third parties; quick response (QR) codes or barcodes for players to easily access and download robot and game control apps; and graphics to attract attention to the game. Game mats may be rolled up for easy storage, and have wider and longer dimensions than the bumpers on table to keep edges of the mat from rolling up when placed on table. Game mats may be made from various materials illustratively including plastic, vinyl, cloth, or foam.

Pocket blocks (Corner and Side)—force balls to be placed in particular pockets during game play.

Pocket blocks with ball stalls (corner, side, and center)—enable individual placement of balls in designated stalls or slots to make games more challenging

Corner, side, and center gate modules—Corner, side, and center gate modules may contain motorized gates, scoring bumpers, ball kickers, sensors for scoring balls, etc.

In a specific inventive embodiment of the game each of the players simultaneously race against each other to see who is first to push their assigned balls into the pockets of the billiards table. The fast pace of the game, the lack of waiting for other players, and eliminating the need to track whose turn it is make for a fast and enhanced gaming experience for players. The player who wins the most games in a match of multiple games is the overall winner.

In another specific embodiment of the game, a single player or a group of players each individually races the clock to see who is fastest to push their assigned balls into the pockets of the billiards table. In this example, the number of assigned balls could be any number from one to fifteen.

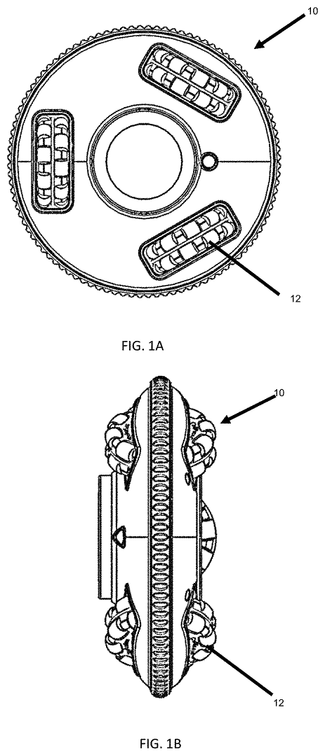

Referring now to the figures, FIGS. 1A and 1B are a side view and bottom view, respectively of an embodiment of a robot 10 that may be propelled and steered by drive wheels 12. As shown in FIGS. 2A and 2B, one or more attachments 14 (arms, probes, pushers, etc.) may be joined to the robot 10 so that a robot can guide and/or strike the balls and get the balls out of situations where the ball is stuck.

FIG. 3 is an overall view of a system 20 for implementing embodiments of the inventive games. The system 20 includes a game table 22, which may be a billiard/pool/snooker table, with a gaming surface 24 set of bumpers 26 along the perimeter sides of the table 10. It is appreciated that other shaped tables illustratively including a pentagon or octagon with pockets in the corners may be adapted for gameplay. A set of corner pockets 28 and side pockets 30 are positioned at the four corners and on the two sides of the table, respectively for collecting balls. One or more robots 12 are in wireless communication with a set of controllers 32. The one or more robots 10 and set of controllers 32 may be networked to a computer 34 for playing games.

During game play, the one or more robots 10 may be placed at a specified location on the game surface 24 prior to beginning a game. Players compete to get their assigned balls 36 into pockets (28, 30) first with their assigned robot 10. The controller 32 may be a dedicated wireless controller provided by the game table venue on a rental basis, or a tablet or smartphone loaded with a downloadable application (app) that is brought to the game table venue by the player. The game table venue may have a central computer 34 that networks with the robots 10, the dedicated player controllers 32, or with the app on the smartphones or tablets. Networking may be carried out via a Wi-Fi network 36 with coverage over the entire game table venue. The central computer 34 may be used to track game results, times, player standings, and other game related statistics. As shown in FIGS. 2A and 2B, embodiments of the robots 10 may have attachments 14 (arms, probes, pushers, etc.) so that a robot 10 can guide and/or strike the balls, as well as get the balls out of situations where the ball is stuck.

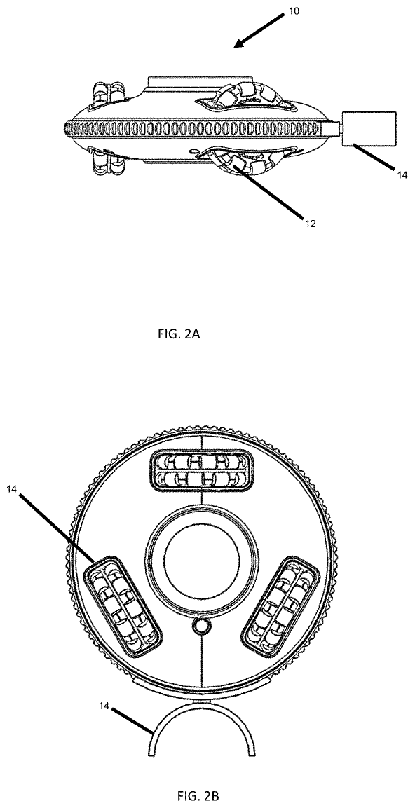

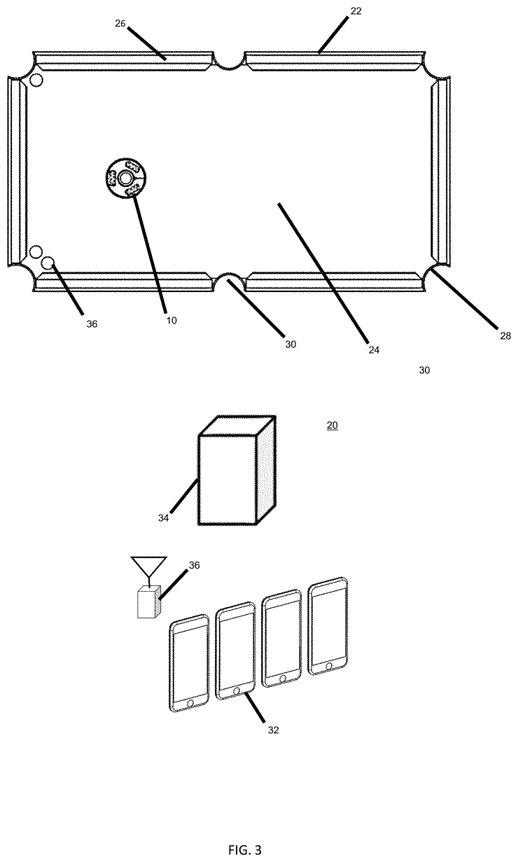

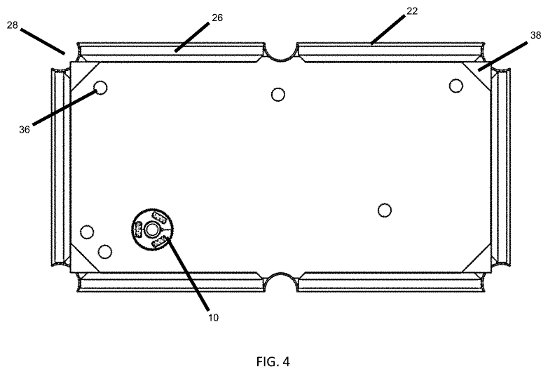

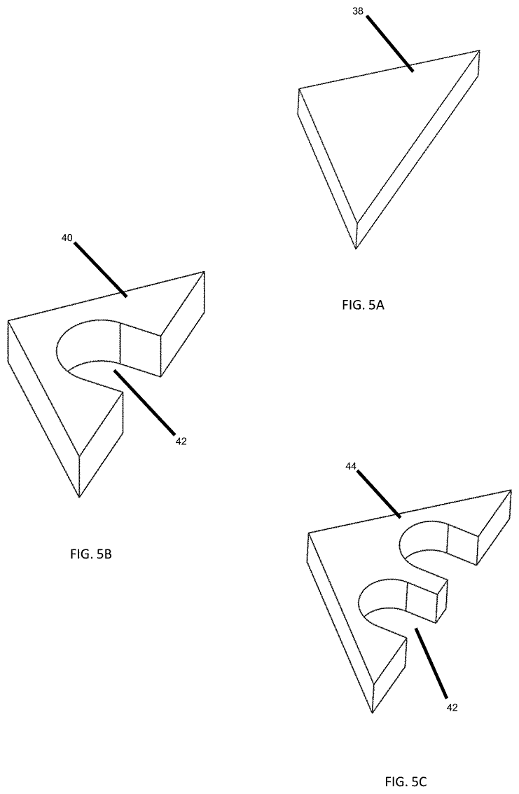

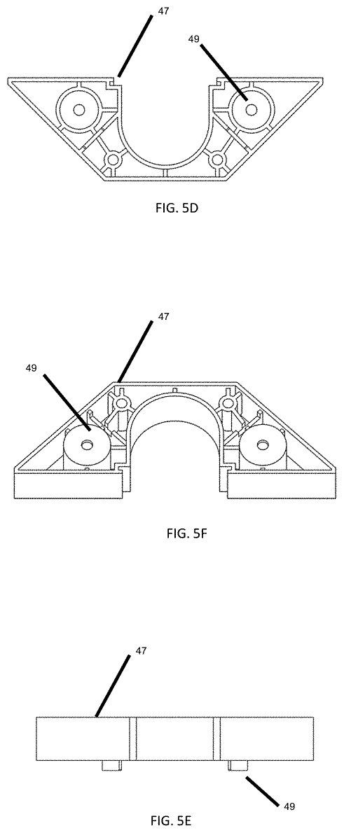

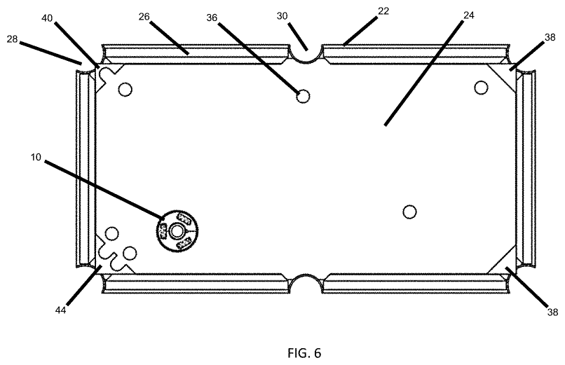

FIG. 4 is a top view of an embodiment of a table 22 with corner blocks 38 placed in front of the corner pockets 28, thereby precluding the balls 36 from entering the corner pockets 28. FIG. 5A is a detailed close up perspective view of a corner block 38 of FIG. 4. The corner block 38 may be made of foam, wood, metal, or plastic. FIG. 5B is a perspective view of a single stall corner block 40 with one ball stall slot 42, where the ball stall slot 42 is used to place a single game ball during game play. The single stall corner block 40 may be made of foam, wood, metal, or plastic. FIG. 5C is a perspective view of a multi stall corner block 44 with multiple ball stall slots 42 to place multiple game balls in during game play. FIG. 6 is a top view of an embodiment of a table 22 with the various corner blocks (corner block 38, single stall corner block 40, multi stall corner block 44) shown in FIGS. 5A-5C positioned in front of the corner pockets 28. An additional corner block is shown generally at 47 in FIGS. 5D-F and includes tabs 49 for locating the block 47 on a foam mat.

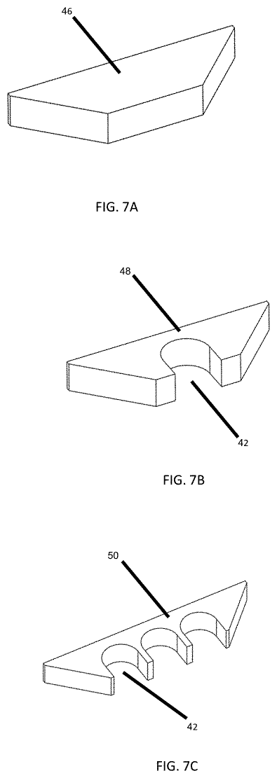

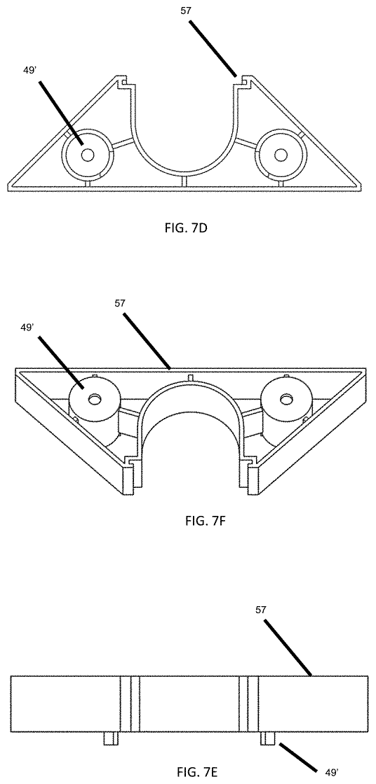

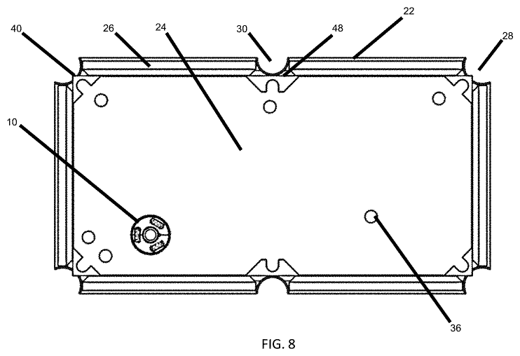

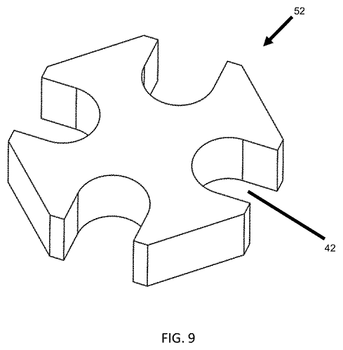

FIGS. 7A-7C are perspective views of a side block 46, a single stall side block 48 with one ball stall slot 42, and a multi stall side block 50 with multiple ball stall slots 42 to place multiple game balls in during game play. Embodiments of the side block 46, single stall side block 48, and multi stall side block 50 may be made of foam, wood, metal, or plastic. FIG. 8 is a top view of an embodiment of a table 22 with two of the single stall side blocks 48 positioned in front of the side pockets 30, and four single stall corner blocks 40 positioned in front of the corner pockets 28. An additional side block is shown generally at 57 in FIGS. 7E-F and includes tabs 49′ for locating the block 57 on a foam mat. It is appreciated that in those embodiments where the substrate is a hard surface such as a floor or table, tab 49 or 49′ is readily replaced with suction cups

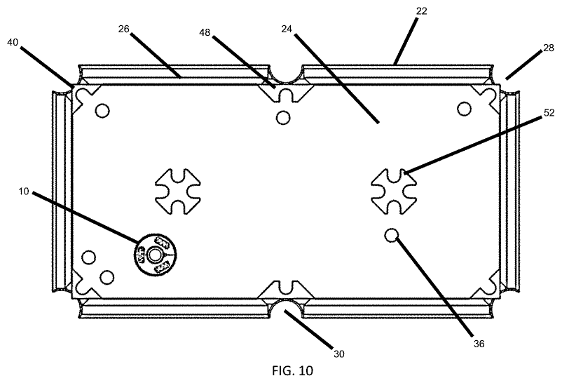

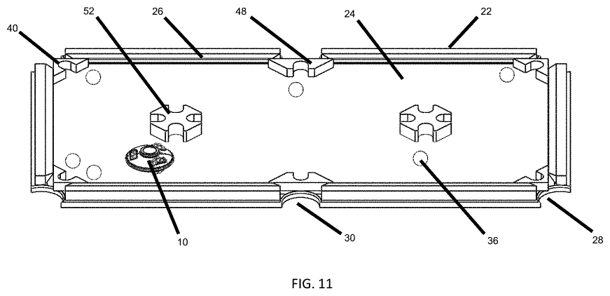

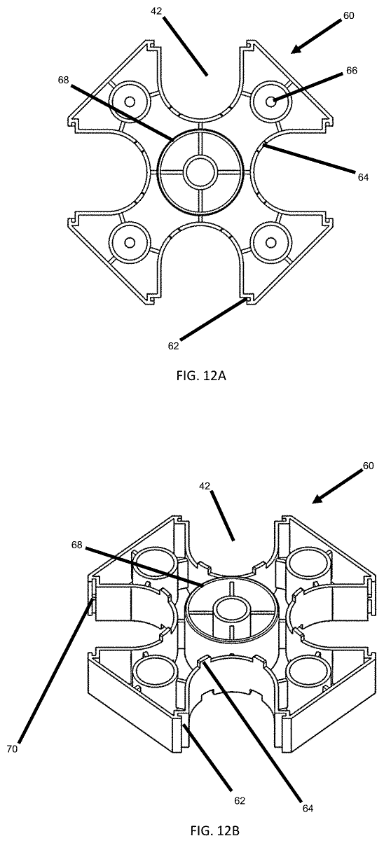

FIG. 9 is a perspective view of a multi stall center block 52 with multiple ball stall slots 42 to place multiple game balls in during game play. Embodiments of the multi stall center block 52 may be made of foam, wood, metal, or plastic. FIG. 10 is a top view of an embodiment of a table 22 with four single stall corner blocks 40, two single stall side blocks 48, and two multi stall center blocks 52. FIG. 11 is a side perspective view of the table 22 shown in FIG. 10 with the four single stall corner blocks 40, two single stall side blocks 48, and two multi stall center blocks 52, where the total number of stalls (ball slots) 42 in this configuration is fourteen, which corresponds to the maximum number required for an equal number of stripe and solid pool balls so that each ball has an available stall slot.

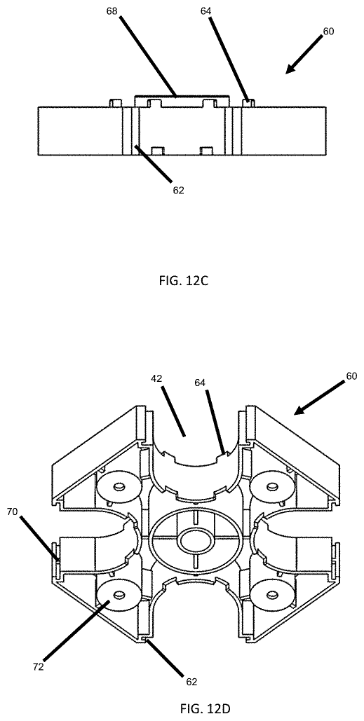

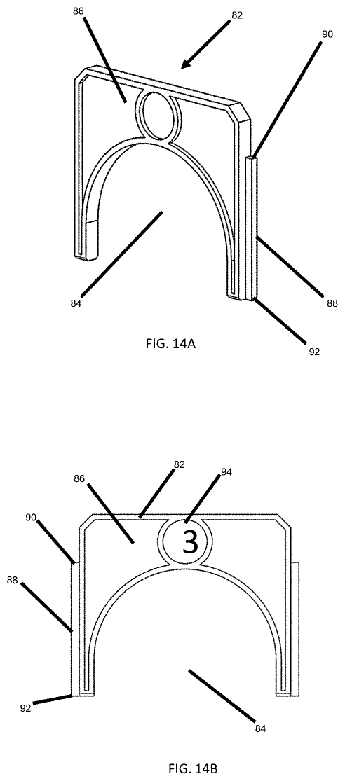

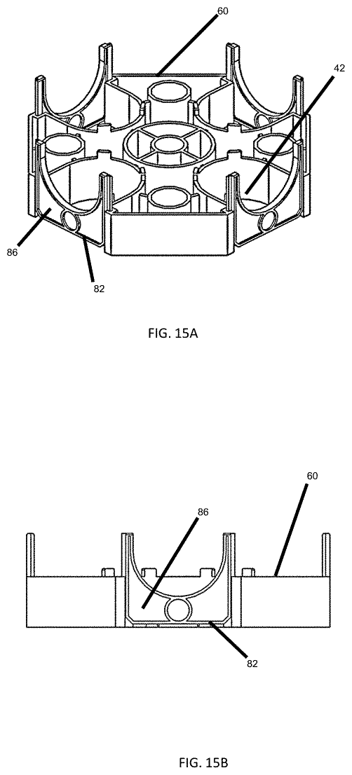

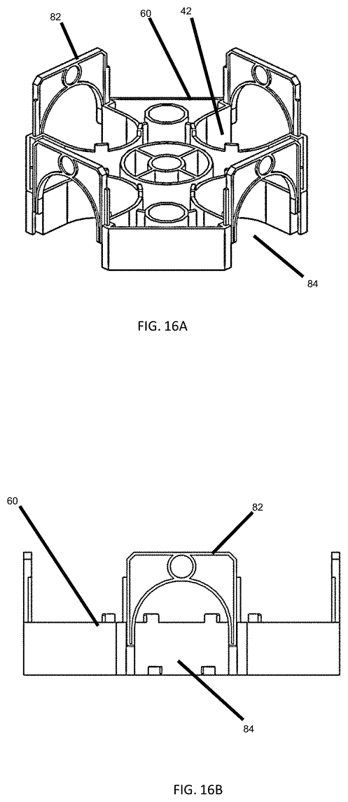

FIG. 12A is a top view of an embodiment of a multi stall center block 60 with mounting grooves 62 for the addition of gates 82 (described further in FIGS. 14A and 14B) and mounting holes 66 for securement of the multi stall center block 60 to horizontal surfaces with screws or bolts.

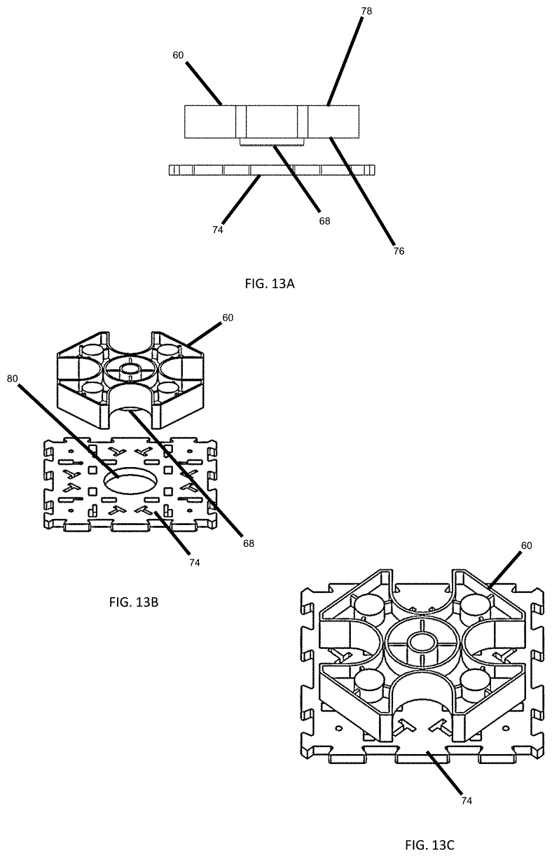

FIG. 12B is a perspective view of the multi stall center block 60 with stops 70 in the mounting grooves 62 for gates 82 in the open and closed positions (described further in FIGS. 15 and 16), as well as anti-rotation tabs 64 for locking the multi stall center block 60 to a foam stadium mat 74 in a desired orientation as shown in FIGS. 13A-13C.

FIG. 12C is a side view of a multi stall center block 60 with a locating feature 68 to position the multi stall center block 60 on a foam stadium mat 74 in a desired location.

FIG. 12D is an underside perspective view of a multi stall center block 60 with pads 72 to locate and secure Velcro™ hook patches (hook and loop) or suction cups which are used to hold the multi stall center block 60 in place on a game mat, table, or floor.

FIG. 13A is a side view of a reversible multi stall center block 60 above a foam stadium mat 74 with a top side 78 for mounting to a floor, table, or game mat, and a bottom side 76 for mounting to the foam stadium mat 74. FIG. 13B is a perspective view of the multi stall center block 60 above the foam stadium mat 74 of FIG. 13A showing a locating feature 80 for positioning the multi stall center block 60. FIG. 13C is a perspective view of the multi stall center block 60 positioned on the foam stadium mat 74.

FIG. 14A is a view of a reversible block gate 82 with an opening 84 for a game ball 36 to pass through and a wall 86 to block a ball 36 from passing through, with a set of tabs 88 to locate the reversible block gate 82 in the horizontal plane and stops (90, 92) to locate the reversible block gate 82 in the vertical plane of the multi stall center block 60. Stop 90 is used in a gate closed position, and stop 92 is used in a gate open position as shown further in FIGS. 15 and 16. Tabs 88 fit into mounting grooves 62. FIG. 14B is a view of a reversible block gate 82 with a game ball number indicator 94 that is used during game play to determine a required ball that is to be placed in a particular ball stall slot 42.

FIG. 15A is a perspective view of a multi stall center block 60 with block gates 82 installed in the closed position, thereby not allowing or preventing a ball 36 to enter a ball stall slot 42. FIG. 15B is a front view of a FIG. 15A showing the multi stall center block 60 with the reversible block gates 82 installed in the closed position. It is appreciated that a multi stall center block 60 may be configured with some gates 82 of the multi stall center block 60 installed in the closed position at the same time that other gates of the multi stall center block 60 are in an open position.

FIG. 16A is a perspective view of a multi stall center block 60 with block gates 82 installed in the open position to allow balls 36 to enter the ball stall slots 42. FIG. 16B is a front view of FIG. 16A showing the multi stall center block 60 with block gates 82 installed in the open position. It is appreciated that a multi stall center block 60 may be configured with some gates 82 of the multi stall center block 60 installed in the open position at the same time that other gates of the multi stall center block 60 are in a closed position.

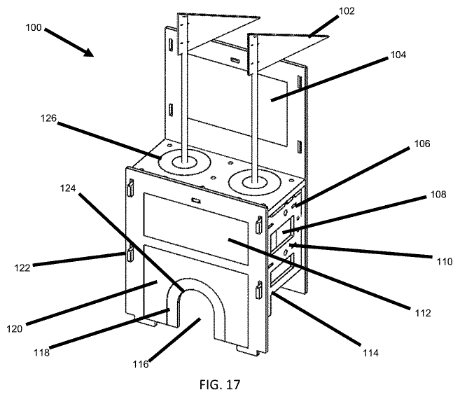

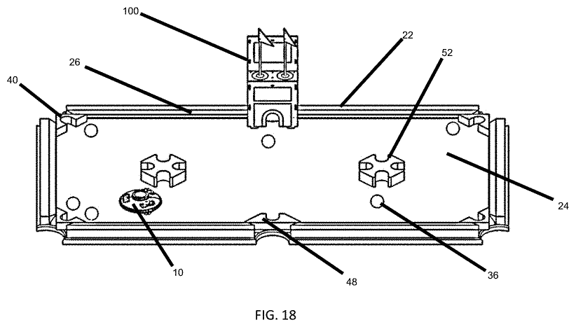

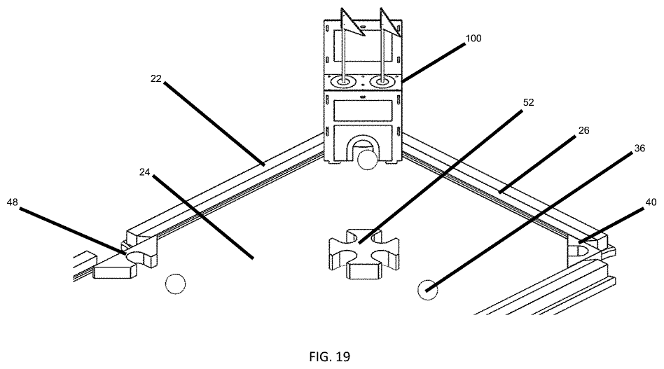

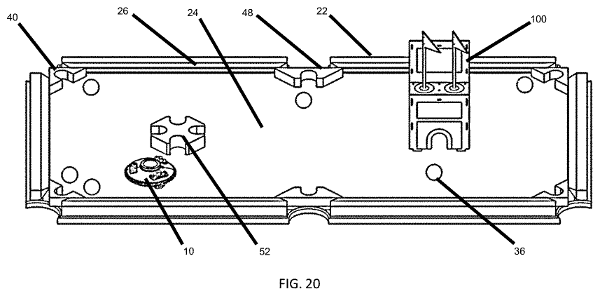

FIG. 17 is a detailed perspective view of an embodiment of a gate module 100 featuring decorations 102, displays 104, communications 106, electronics 108, batteries 110, robot weapon targets 112, sensors 114, scoring goals 116, ball kickers 118, scoring bumpers 120, indicator lights 122, motorized gates 124, and power receivers 126 for receiving transmitted power. FIG. 18 is a perspective view of a table 22 configured with four single stall corner blocks 40, a single stall side block 48, and a gate module 100 in a side position on the table. FIG. 19 is a partial perspective view of a table 22 showing a single stall side block 48, a single stall corner blocks 40, and a gate module 100 in a corner position on the table 22. FIG. 20 is a perspective view of a table 22 configured with four single stall corner blocks 40, two single stall side blocks 48, and a gate module 100 in a central position on the table 22.

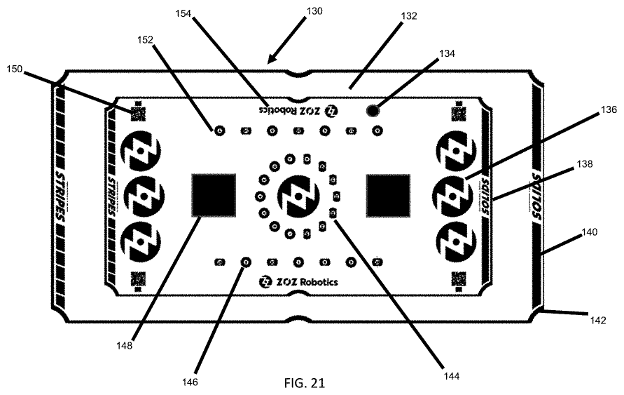

FIG. 21 is a top view of an inventive embodiment of a game mat 130 featuring different size table graphics 132, indicators for locating Velcro loops to secure blocks 134, indicators for robot starting point locations 136, game play graphics 138, extended edges to tuck under table bumpers 140, cut lines for pool and snooker table pockets 142, indicators for game ball starting locations 144, indicators for alternate game ball starting locations 146, indicators for locating blocks 148, QR codes 150 for accessing apps and websites, cosmetic graphics 152, and advertising graphics 154. The game mat may be placed over the surface 24 of a game table 22. It is appreciated that alternative shaped game mats may be formed to match the shape of the game table 22.

The foregoing description is illustrative of particular embodiments of the invention, but is not meant to be a limitation upon the practice thereof.

1. A game played on a billiards/pool/snooker table comprising:
at least one robot assigned to temporally to one of two or more players or two or more robots each assigned uniquely to each of the two or more players;
a remote controller in electrical or wireless communication with the at least one robot or the two or more robots, each of the individually two or more remote controllers assigned to the two or more players for control of the two or more robots; and
two or more color-coded or numbered balls.

2. The game of claim 1 wherein the two or more remote controllers are dedicated wireless controllers.

3. The game of claim 1 wherein the two or more remote controllers are a tablet or smartphone having a downloadable application (app) for controlling the assigned robot.

4. The game of claim 1 wherein the two or more remote controllers are a tablet or smartphone having a downloadable application (app) for tracking parameters of the game.

5. The game of claim 1 further comprising a central computer, the central computer networked with the two or more robots and with the two or more remote controllers.

6. The game of claim 5 wherein the central computer is networked via Wi-Fi with the two or more robots and with the two or more remote controllers.

7. The game of claim 5 wherein the central computer tracks game results and times.

8. The game of claim 1 wherein at least one of the two or more robots further comprises one or more attachments adapted to engage to one of the two or more balls so as to guide, strike, extricate, or a combination thereof.

9. The game of claim 8 wherein the one or more attachments is an arm, a probe, or a pusher.

10. The game of claim 1 wherein the two or more players simultaneously race to place their assigned balls into the pockets of the billiards/pool/snooker table.

11. The game of claim 1 wherein a player of the two or more players wins with the lowest overall time to place their assigned balls into the pockets of the billiards/pool/snooker table.

12. The game of claim 1 wherein teams of players play together.

13. The game of claim 1 further comprising a set of corner blocks and a set of side blocks that are placed in front of corner pockets and side pockets, respectively, of the billiards/pool/snooker table;
wherein the set of corner blocks have a combination of corner blocks with none, one, two or more ball stall slots; and
wherein the set of side blocks have a combination of side blocks with none, one, two or more ball stall slots.

14. The game of claim 1 further comprising one or more multi stall center blocks.

15. The game of claim 14 wherein each of the multi stall center blocks further comprises a set of mounting grooves for securement of a set of reversible gates, where the set of reversible gates are positioned in combinations of open and closed positions.

16. The game of claim 15 wherein each of the multi stall center blocks further comprises one or more of holes.

17. The game of claim 13 wherein corner and side blocks also have the mounting grooves or holes.

18. The game claim 1 further comprising a gate module, the gate module further comprising one or more of: decorations, displays, communications, electronics, batteries, robot weapon targets, sensors, scoring goals, ball kickers, scoring bumpers, indicator lights, motorized gates, and power receivers for receiving transmitted power.

19. The game of claim 1 further comprising a game mat, the game mat further comprising one or more of: different size table graphics, indicators for locating hook and loops to secure a set of blocks, indicators for robot starting point locations, game play graphics, extended edges to tuck under a set of table bumpers, cut lines for pool and snooker table pockets, indicators for game ball starting locations, indicators for alternate game ball starting locations, indicators for locating blocks, quick response (QR) codes for accessing apps and websites, cosmetic graphics, and advertising graphics.

20. The game of claim 1 wherein at least one of the two or more color-coded or numbered balls has a game ball number indicator associated with a specific ball pocket.
